(19) United States
(12) Patent Application Publication
(10) Pub. No.: US 2013/0194567 A1
(43) Pub. Date: Aug. 1, 2013

(54) SYSTEM AND METHOD FOR WIND TURBINE BLADE INSPECTION

(71) Applicant: GENERAL ELECTRIC COMPANY, Schenectady, NY (US)

(72) Inventors: Xinjun Wan, Shanghai (CN); Kevin George Harding, Niskayuna, NY (US); Shukuan Xu, Shanghai (CN); Peter James Fritz, Commerce Township, MI (US); Guiju Song, Niskayuna, NY (US); Guangping Xie, Shanghai (CN)

(73) Assignee: GENERAL ELECTRIC COMPANY, Schenectady, NY (US)

(21) Appl. No.: 13/754,946

(22) Filed: Jan. 31, 2013

(30) Foreign Application Priority Data
Jan. 31, 2012 (CN) 201210021267.X

(51) Int. Cl. G01B 11/14; G01B 11/26

(52) U.S. Cl. CPC G01B 11/14; G01B 11/26
USPC 356/152.1; 356/614

(57) ABSTRACT

A system for inspection of a blade of a wind turbine in operation is provided. The system comprises a light projection unit, an imaging unit and a processing unit. The light projection unit generates and projects a light pattern towards a blade of a wind turbine in operation. The imaging unit captures a plurality of scanning light patterns on the blade of the wind turbine during rotation of the blade. The processing unit is configured to process the plurality of the captured d light patterns from the imaging unit for inspection of deflection of the blade. A method for inspection of a blade of a wind turbine in operation is also presented.

### BACKGROUND OF THE DISCLOSURE

The invention relates generally to systems and methods for wind turbine blade inspection. More particularly, the invention relates to systems and methods for inspection of deflection of blades of wind turbines.

With increasing attention to environment and climate, wind turbines have been widely used to convert wind energy into energy in other forms, such as of electrical energy. Typically, wind turbines employ blades to capture and transmit kinetic energy from wind through rotational energy for facilitating conversion of the kinetic energy into electrical energy.

In order to increase energy output, blades of wind turbines have larger sizes. However, due to the larger sizes of the blades, during operation, wind load causes the blades to deflect resulting in increasing of the tendency of fatigue of the blades and striking between the blades and towers of the wind turbines. In addition, at a certain wind load on the wind turbines, the blades are generally designed to have respective theoretical deflection curves. Thus, it is desirable to inspect deflection of the blades of the wind turbines not only to verify the blade design with real field data but also evaluate the health of the blades during operation.

There have been attempts to inspect the deflection of blades of the wind turbines. For example, sensors are mounted on the blades to detect deflection thereof. However, such techniques involve modification of the blades to assemble the sensors thereon and may increase the difficulties of assembly and maintenance of such wind turbines.

Therefore, there is a need for a new and improved system and method for inspection of blades of wind turbines.

### BRIEF DESCRIPTION OF THE DISCLOSURE

A system for inspection of a blade of a wind turbine in operation is provided in accordance with one embodiment of the invention. The system comprises a light projection unit, an imaging unit and a processing unit. The light projection unit generates and projects a light pattern towards a blade of a wind turbine in operation. The imaging unit captures a plurality of scanning light patterns on the blade of the wind turbine during rotation of the blade. The processing unit processes the plurality of the captured light patterns from the imaging unit for inspection of deflection of the blade.

A method for inspection of a blade of a wind turbine in operation is provided in accordance with another embodiment of the invention. The method comprises generating and projecting a light pattern onto a blade of a wind turbine in operation; capturing a plurality of scanning light patterns on the blade of the wind turbine during rotation of the blade; and processing the plurality of the captured light patterns from the imaging unit separately for inspection of deflection of the blade.

These and other advantages and features will be more understood from the following detailed description of preferred embodiments of the invention that is provided in connection with the accompanying drawings.

### BRIEF DESCRIPTION OF THE DRAWINGS

FIG. 1 is a schematic diagram of a system for wind turbine blade inspection in accordance with one embodiment of the invention;

FIG. 2 is a schematic diagram of a light projection unit of the system in accordance with one embodiment of the invention;

FIGS. 3-7 are schematic diagrams of light patterns on a blade of a wind turbine in accordance with various embodiments of the invention;

FIG. 8 is a schematic diagram of the system for wind turbine blade inspection in accordance with another embodiment of the invention; and

FIG. 9 is an exemplary experimental chart showing curves of flapwise coordinates of three spanwise positions on the blade inspected by the system shown in FIG. 1.

### DETAILED DESCRIPTION OF THE INVENTION

Preferred embodiments of the present disclosure will be described hereinbelow with reference to the accompanying drawings. In the following description, well-known functions or constructions are not described in detail to avoid obscuring the disclosure in unnecessary detail.

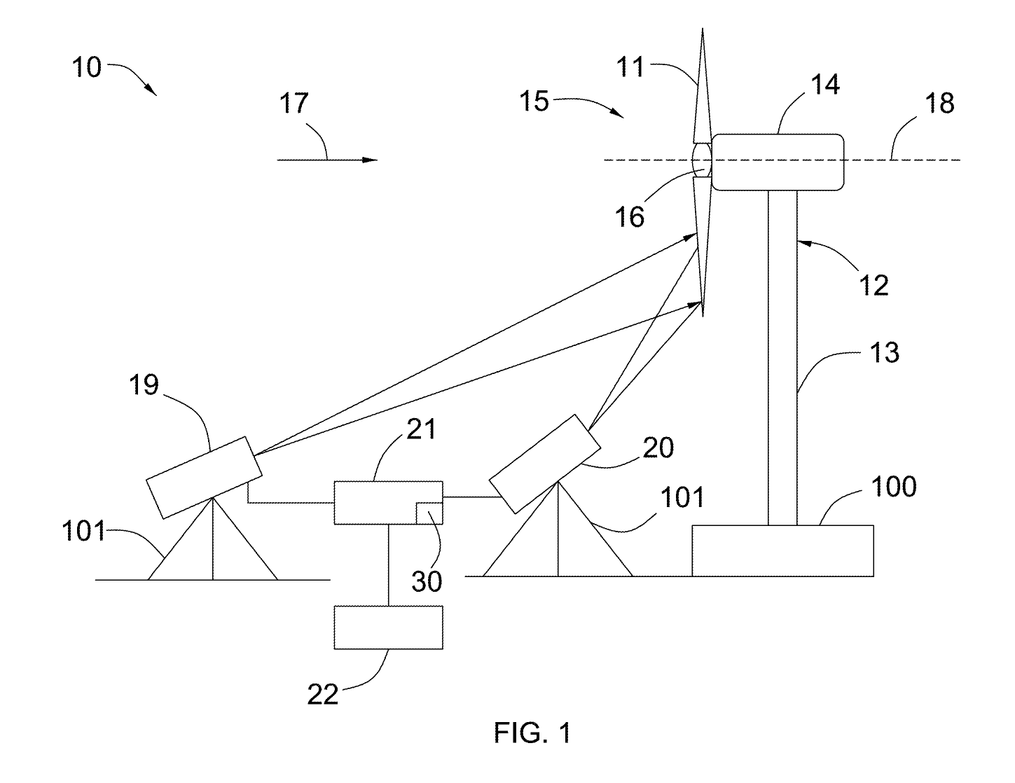

FIG. 1 is a schematic diagram of a system 10 for inspection of at least one blade 11 of a wind turbine 12 in accordance with one embodiment of the invention. As illustrated in FIG. 1, the wind turbine 12 comprises a tower 13, a nacelle 14 assembled onto an upper end (not labeled) of the tower 13, and a rotor 15. The tower 13 extends from a support structure 100, such as the ground or a platform or foundation, and may have any suitable height and shape to define a cavity (not shown) between the nacelle 14 and the support structure 100. The rotor 15 comprises a rotatable hub 16 and the at least one blade 11. The rotatable hub 16 is coupled to the nacelle 14 and the at least one blade 11 is coupled to and extending outward from the hub 16.

In the illustrated example, the wind turbine 12 comprises a plurality of blades 11, for example three blades. The blades 11 are disposed around the hub 16 and spatially spaced from each other so that the blades 11 rotate with the rotation of the rotatable hub 16 of the rotor 15 to capture and transmit kinetic energy from wind through rotational energy so as to convert of the kinetic energy into energy in other forms, such as electrical energy.

In some embodiments, each of the blades 11 may have a length in a range of from about 15 m to about 91 m. Alternatively, each blade 11 may have any other suitable length to capture the kinetic energy from wind. During operation of the wind turbine 12, as wind strikes the blades 11 from a direction 17, the rotor 15 rotates about an axis of rotation 18 to rotate the blades 11 to capture and transmit the kinetic energy from wind.

The blades 11 may be subjected to wind load and other forces, such as centrifugal forces. This may result in the blades 11 deflecting from a neutral, or non-deflected, position to a deflection position. In embodiments of the invention, in order to ensure safe and stable operation of the wind turbine 12, the system 10 is employed to inspect deflection of the at least one blade 11 of the wind turbine 12 so as to evaluate the health of the blades during operation and/or verify the blade design with real field data. As used herein, the term “deflection” includes flapwise bending and/or torsional twist.

It should be noted that in the illustrated example, although the wind turbine 12 comprises a horizontal axis wind turbine, the wind turbine 12 may alternatively comprise a vertical axis wind turbine. For ease of illustration, some elements of the wind turbine 12 are not illustrated.

As depicted in FIG. 1, the system 10 comprises a light projection unit 19, an imaging unit 20, a processing unit 21, and a monitor 22. The light projection unit 19 is configured to project at least one light pattern onto the blades 11 of the wind turbine 12. For the illustrated arrangement, the light projection unit 19 is disposed separately. Alternatively, the light projection unit 19 may be connected to and controlled by the processing unit 21 to generate and project the at least one light pattern.

In some examples, the light projection unit 19 may comprise at least one light source to directly generate and project the at least one light pattern onto the respective blades 11. In non-limiting examples, the light projection unit 19 may further comprises optical elements (not shown) including, but not limited to lens for facilitation of projection of the at least one light pattern from the light source onto the respective blades 11.

In one application, the at least one light source may include a white light source. Other non-limiting examples of light sources include a mercury arc lamp, a metal halide arc lamp, a halogen lamp, a laser/phosphor system, a fiber coupled laser, a LED based light source, and a laser. FIG. 1 also illustrates tripods 101 and a trigger 30 which will be described in more detail below.

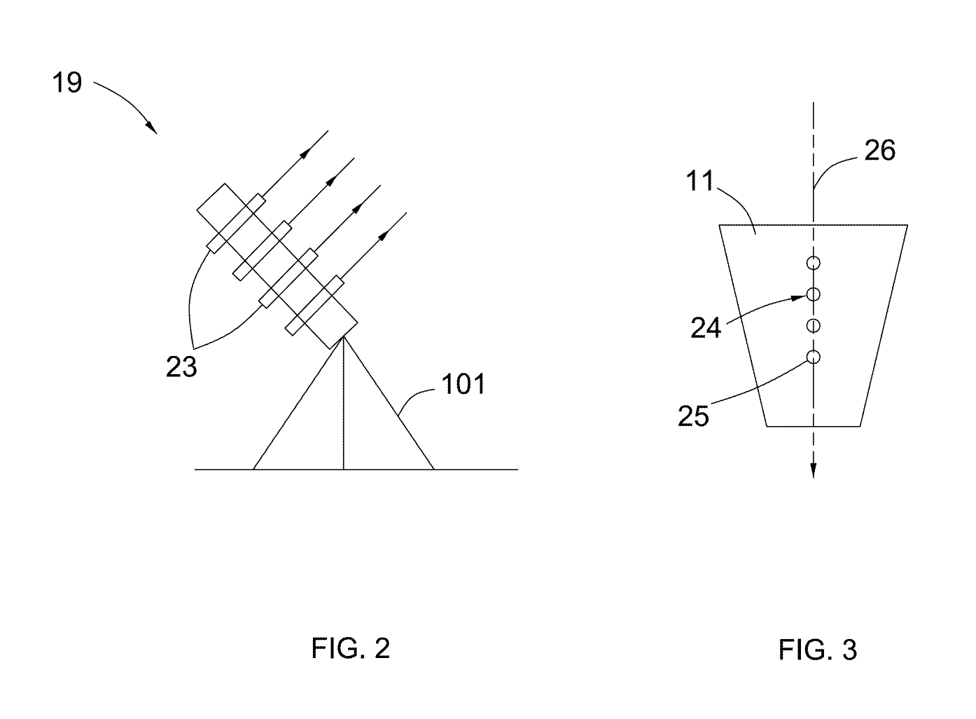

FIG. 2 illustrates a schematic diagram of the light projection unit 19 in accordance with one embodiment of the invention. As illustrated in FIG. 2, the light projection unit 19 comprises a plurality of light sources 23 to project a plurality of light patterns onto the blades 11. In other examples, a single light source 23 may be employed to project one or more light patterns onto the blades 11 with employment of one or more light splitting elements (not shown).

In non-limiting examples, different light patterns may be projected onto the respective blades 11 by the light projection unit 19. FIGS. 3-7 illustrate schematic diagrams of the light pattern 24 on the blades 11 in accordance with various embodiments of the invention. For ease of illustration, the light patterns are shown with circular light markers, for example light dots. Alternatively, non-limiting of the light markers may include any other suitable shapes. Such light markers are most likely when the blades 11 do not rotate or rotate in a relatively low speed. At a higher speed, the shapes of the light markers are changed, but the general processing approach will still be applicable.

As illustrated in FIG. 3, the light pattern 24 comprises a column of four light markers 25 disposed along a top to bottom direction 26 and spaced away from each other in a certain interval. In this exemplary example, the light markers 25 comprise light dots. Based on different inspection requirements, the intervals between two adjacent light markers 25 may vary.

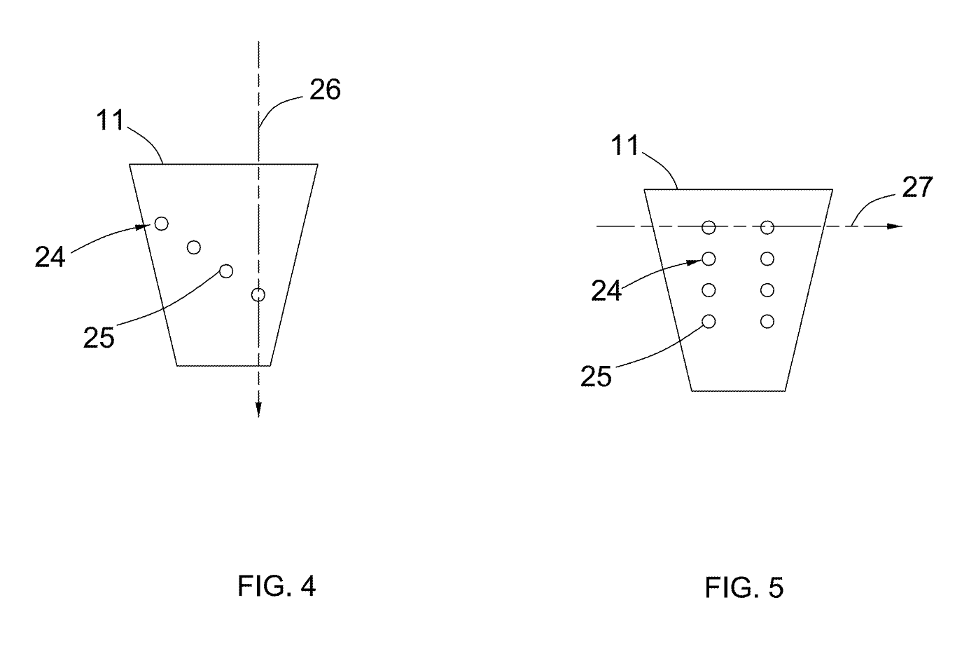

In some applications, the light pattern 24 may comprise a plurality of columns of light dots 25 and/or each of the columns may comprise at least one light dot 25. As illustrated in FIG. 4, the light pattern 24 comprises four columns of the light dots and each column comprises a single light dot 25. For the illustrated arrangement, the light dots 25 are spaced away from each other along the top to bottom direction 26 so that the light dots 25 are not disposed in the same row but disposed in an interleaving format. Alternatively, the light dots 25 may be disposed in the same row along a left to right direction 27 (shown in FIG. 5).

In one embodiment, as illustrated in FIG. 5, the light pattern 24 comprises two columns of the light dots 25 disposed parallel to each other with each column including a plurality of the light dots 25. For the illustrated arrangement, the adjacent light dots 25 in the different columns are disposed in the same respective rows along the left to right direction 27. Alternatively, the adjacent light dots 25 in the different columns may not be disposed in the same respective rows but disposed in interleaving format similar to the arrangement in FIG. 4.

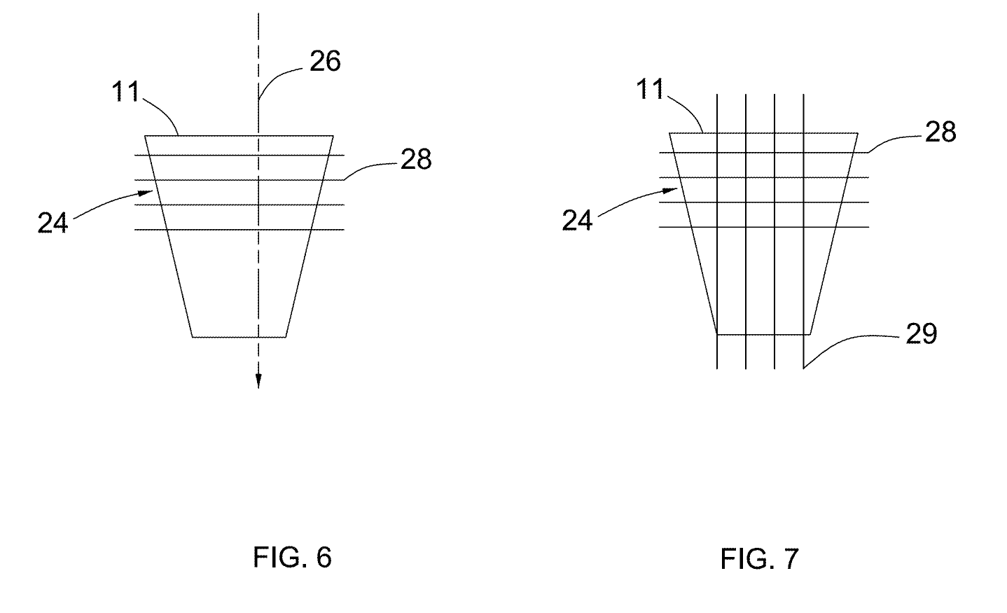

In addition, the light pattern 24 may comprise other patterns, such as at least one light marker 28 in a form of linear light line(s) disposed spaced away from each other and along the top to bottom direction 26, as illustrated in FIG. 6, or a pattern formed by crossed linear light lines 28, 29, as illustrated in FIG. 7. Similar to the arrangement in FIG. 3, the intervals between adjacent light lines 28 or 29 may be the same or different. It should be noted that the light pattern 24 includes, but not limited to the arrangements shown in FIGS. 3-7. In one non-limiting example, the light pattern 24 comprises the light pattern 24 shown in FIG. 4 so that due to the interleaving arrangement of the light dots 25, not only flapwise bending but also torsional twist of the blades may be inspected.

Based on the different arrangements of the light pattern 24, the arrangements of the at least one light source 23 of the light projection unit 19 may be adjusted accordingly. For example, in one embodiment, a plurality of light sources 23 are employed and arranged in one or more columns.

For the illustrated arrangement in FIG. 1, the imaging unit 20 is configured to capture or image light patterns on the respective blades 11 and transmit the captured light patterns to the processing unit 21 for processing. In non-limiting examples, during rotation of the blades 11, the captured light patterns from the respective blades 11 may be in formats of light curves.

In some examples, the imaging unit 20 may comprise one or more charge-coupled device (CCD) sensors or any other suitable imaging devices having relatively higher light-sensitive pixels to sense the light level of the light patterns. In certain applications, the blades 11 rotate in a high speed during operation of the wind turbine 12 and thus the imaging unit 20 may comprise a high-speed camera.

The processing unit 21 is configured to process the captured light patterns images from the imaging unit 20 determine position information thereof. In one non-limiting example, the processing unit 21 is configured to process the images from the imaging unit 20 separately. As used herein, the term “separately” means the processing of one image is separated from the processing of another image so as to obtain separated processing results based on the respective processed images. The monitor 22 may comprise a display, such as, a liquid crystal display (LCD), to display the analysis results for users to observe.

The processing unit 21 is not limited to any particular processor for performing the processing tasks of the invention. The term “processor”, as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output, as will be understood by those skilled in the art.

In non-limiting examples, for facilitating the imaging unit 20 to capture the images of the light patterns on the respective blades 11 at useful points in time, the imaging unit 20 may further comprise a trigger 30 to trigger the imaging unit 20 to capture the images of the light patterns. For example, gray scale differences are determined between the respective images sensed by the imaging unit 20 when the blades 11 pass through and no blades 11 pass through a field of view (FOV) of the imaging unit 20. Thus, the trigger 30 triggers the imaging unit 20 to capture the images of the light patterns when the gray scale differences reach a certain level so as to save the capacity of the imaging unit 20. In other applications, the trigger may be disposed onto the processing unit 21 to trigger the imaging unit 20.

In the illustrated example in FIG. 1, the light projection unit 19 and the imaging unit 20 are positioned fixedly relative to the wind turbine 12 for facilitation of inspection of the deflection of the blades 11. The light projection unit 19 is disposed in front of and in a distance away from the wind turbine 12. The imaging unit 20 is disposed between the wind turbine 12 and the projection light unit 19. Although the light projection unit 19 and imaging unit 20 are disposed separately and supported by respective tripods 101 for facilitation of the inspection of the system 10, the light projection unit 19 and the imaging unit 20 may be disposed unitarily, for example on the same supporting element (not shown).

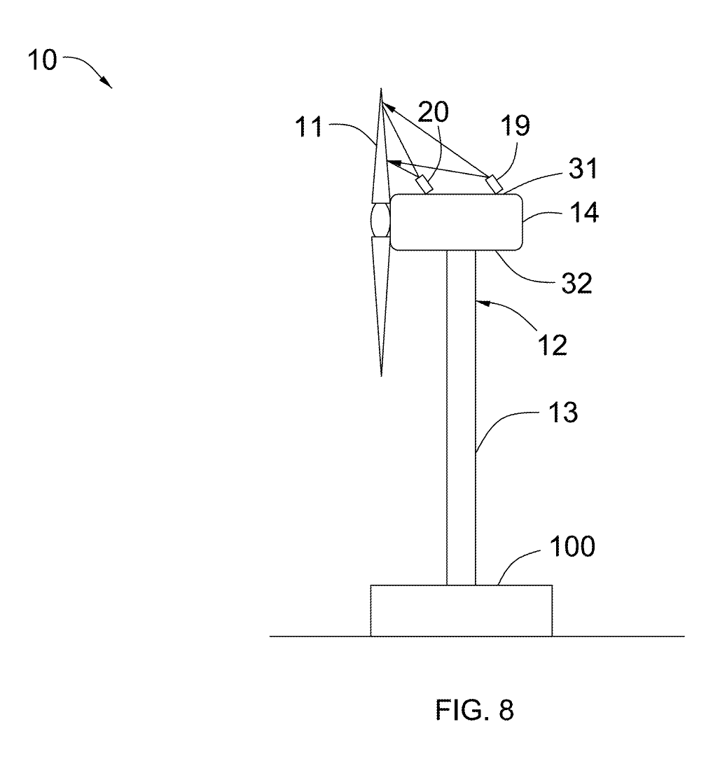

As depicted in FIG. 1, the light projection unit 19 and the imaging unit 20 are positioned on the ground to face upwardly to the blades 11 to perform the inspection. In other examples, the light projection unit 19 and the imaging unit 20 of the system 10 may at least be disposed on other locations, for example on an external upper surface 31 of the nacelle 14 of the wind turbine 12, as illustrated in FIG. 8. Thus, the light projection unit 19 is disposed behind and in a distance from the blades 11. The imaging unit 20 is also disposed between the blades 11 and the light projection unit 19.

The arrangements in FIGS. 1 and 8 are merely illustrative. In non-limiting examples, the light projection unit 19 and the imaging unit 20 may be positioned on an external lower surface 32 of the nacelle 14. Alternatively, the light projection unit 19 and the imaging unit 20 may also be disposed on an interior lower surface (not labeled) of the nacelle 14.

### EXAMPLE

For ease of illustration, a single blade 11 to be inspected and the light pattern 24 including a column of three light dots are used in this Example.

During rotation of the blade 11 in each rotation cycle, each light dot scans a chordwise profile of the blade 11 at the laser-pointed span position so that a plurality of scanning profiles (or scanning light patterns) are produced with the rotation of the blade 11 in respective rotation cycles. As used herein, the term “rotation cycle” means a cycle in which the blade 11 rotates by 360 degrees. Due to rotation of the blade 11, at certain rotation speeds, the scanning profiles may be light curves instead of light dots.

The imaging unit 20 captures or senses the scanning profiles in the rotation cycles. In non-limiting examples, the trigger 30 may be optionally employed to control the imaging unit 20 to capture the scanning light patterns.

Finally, the imaging unit 20 transmits the captured light patterns to the processing unit 21 for processing to determine the position information of respective spanwise positions of the blade 11. In non-limiting examples, for each scanning light pattern or scanning profile, a plurality of data points thereon may be selected and processed to determine the coordinates so as to obtain, for example, an average coordinate or a maximum coordinate acting as the reflection of the position information of one spanwise position on the blade 11.

In certain applications, during processing, the processing unit 21 may calibrate the position information, such as the coordinates of the data points in the images from the imaging unit 20 into respective real spatial coordinates so as to obtain the real spatial position information of the respective spanwise positions on the blade 11.

Accordingly, based on the position information, such as the coordinates obtained from scanning of the blade by each light dot in a plurality of rotation cycles, the changes of the coordinates of each spanwise position on the blade 11 are determined for inspection of deflection of the blade 11. Although performed during the rotation of the blade 11, the inspection may also be performed when the blade is in a neutral, or non-deflected, position for facilitation of comparison with the blade in a rotation state.

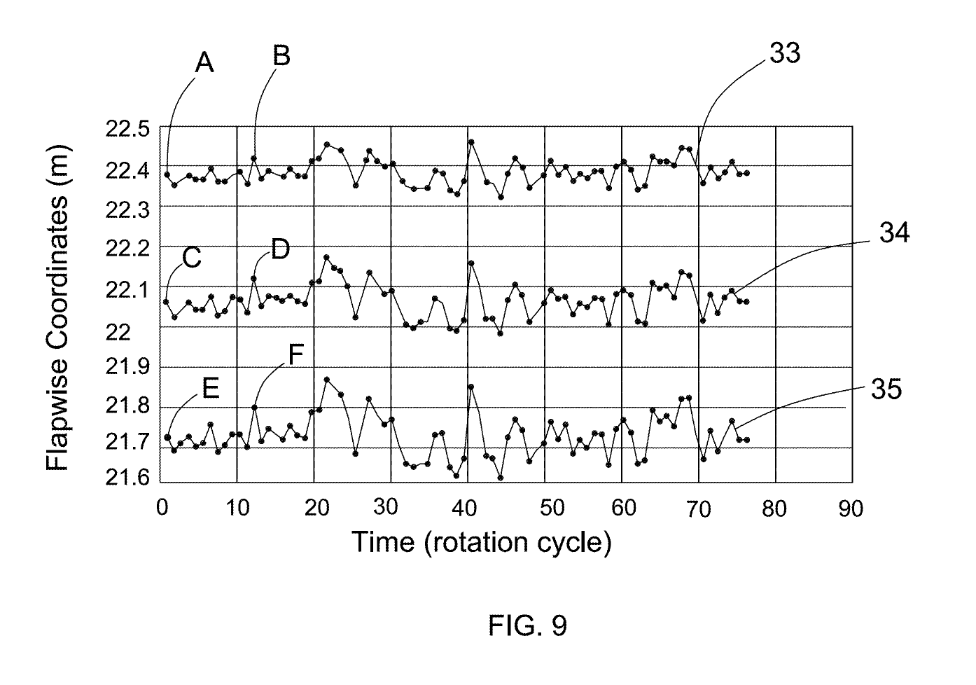

FIG. 9 illustrates an exemplary experimental chart 31 showing changes of flapwise coordinates of three spanwise positions on the blade 11 during rotation of the blade 11. As illustrated in FIG. 9, in this exemplary experiment, curves 33, 34, 35 indicate changes of respective flapwise coordinates of three spanwise positions on the blade 11, which are generated by the scanning of three light dots during rotation of the blade 11. Each of the dots represents a coordinate point of the spanwise position on the blade 11 in one rotation cycle.

Thus, on the same curve 33, 34, or 35, the coordinates generated by the scanning of one light dot in one cycle may be compared to the coordinates generated by the scanning of the one light dot in a previous cycle and/or a next cycle to reflect the position changes of the spanwise position on the blade 11 during rotation of the blade 11. For example, the coordinates of the points, such as the points A and B, the points C and D, or the points E and F on the same curve 33, 34, or 35, which are obtained from the scanning of the same light dot in different rotation cycles, may be compared to reflect the position changes of the spanwise position on the blade 11.

In addition, the coordinates of the points on the different curves 33, 34 and 35, such as the points A, C and E, and the points B, D and F, which are obtained from the scanning of the different light dots in the same rotation cycle, may also be compared to reflect the status of the blade 11 during operation. In other examples, the coordinates of the points on different curves in different rotation cycles, such as the points A, D and F may also be compared.

Thus, based on analysis of the position information inspected by the system 10, the deflection including flapwise bending and torsional twist of the blades 11 may be determined so as to ensure stable and safe operation of the wind turbine 12. In non-limiting examples, the inspection may be performed during rotation of the blades, for example in a high speed. Alternatively, the inspection may also be performed when the blade is in a neutral, or non-deflected, position.

In embodiments of the invention, the system 10 employs the light projection unit 19 and the imaging unit 20 to perform the inspection of the blades 11 of the wind turbine 12. Based on the inspection of the system 10, the deflection of the blades 11 may be determined so as to provide information for the blade design and evaluate the health of the blades during operation to ensure stable and safe operation of the wind turbine.

Compared to conventional inspection systems, the arrangements of the system 10 have a relatively simpler structure and are flexible for the applications thereof. Additionally, the arrangements of the system 10 may be used to inspect not only the flapwise bending but also the torsional twist of the blades 11 to obtain comprehensive inspection information thereof.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A system for inspection of a blade of a wind turbine in operation, comprising:
a light projection unit for generating and projecting a light pattern towards a blade of a wind turbine in operation;
an imaging unit for capturing a plurality of scanning light patterns on the blade of the wind turbine during rotation of the blade; and
a processing unit for processing the plurality of the captured light patterns from the imaging unit for inspection of deflection of the blade.

2. The system of claim 1, wherein the light projection unit is disposed in a distance away from the blade of the wind turbine, and wherein the imaging unit is disposed between the light projection unit and the blade.

3. The system of claim 1, wherein the light projection unit and the imaging unit are disposed fixedly on the ground.

4. The system of claim 1, wherein the light projection unit and the imaging unit are disposed on a nacelle of the wind turbine.

5. The system of claim 1, wherein the light pattern from the light projection unit comprises at least one column with at least one light marker disposed along a top to bottom direction.

6. The system of claim 5, wherein the light pattern comprises a plurality of columns each comprising a single light marker, and wherein the two adjacent light markers are spaced along the top to bottom direction.

7. The system of claim 5, wherein the at least one light marker comprises at least one light dot or at least one linear light line.

8. The system of claim 1, further comprising a trigger configured to trigger the imaging unit to capture the plurality of the scanning light patterns.

9. The system of claim 1, wherein the processing unit is configured to process the captured light patterns separately to obtain respective flapwise coordinates of a spanwise position on the blade in a plurality of rotation cycles of the blade.

10. The system of claim 1, wherein the system is configured to inspect at least one of flapwise bending and torsional twist of the blade.

11. A method for inspection of a blade of a wind turbine in operation, comprising:
generating and projecting a light pattern towards a blade of a wind turbine in operation;
capturing a plurality of scanning light patterns on the blade of the wind turbine during rotation of the blade; and
processing the plurality of the captured light patterns from the imaging unit for inspection of deflection of the blade.

12. The method of claim 11, further comprising selectively triggering the imaging unit to capture the plurality of scanning light patterns on the blade of the wind turbine in operation.

13. The method of claim 12, wherein the step of triggering the capturing is based on gray scale differences when the blade passes through and no blade passes through a field of view.

14. The method of claim 11, wherein the captured light patterns are separately processed for inspection of the deflection of the blade.

15. The method of claim 11, wherein the step of processing the plurality of the captured light patterns generates respective flapwise coordinates of a spanwise position on the blade in a plurality of rotation cycles of the blade.

16. The method of claim 11, wherein the deflection of the blade comprises at least one of flapwise bending and torsional twist of the blade.

17. The method of claim 11, wherein the projected light pattern comprises at least one column with at least one light marker disposed along a top to bottom direction.

18. The method of claim 17, wherein the projected light pattern comprises a plurality of column each comprising a single light marker, and wherein the two adjacent light markers are spaced along the top to bottom direction.

19. The method of claim 17, wherein the at least one light marker comprises at least one light dot or at least one linear light line.
